(19) United States
(12) Patent Application Publication
(10) Pub. No.: US 2002/0109453 A1
(43) Pub. Date: Aug. 15, 2002

(54) Flat-type CRT

(76) Inventor: Jae-Yeul Kim, Seoul (KR)

Correspondence Address: BIRCH STEWART KOLASCH & BIRCH, PO BOX 747, FALLS CHURCH, VA, 22040-0747, US

(21) Appl. No.: 09/929,099

(22) Filed: Aug. 15, 2001

(30) Foreign Application Priority Data
Feb. 14, 2001 (KR) P2001-7362
Feb. 14, 2001 (KR) P2001-7363

(51) Int. Cl. H01J 31/00

(52) U.S. Cl. 313/477 R

(57) ABSTRACT

Disclosed is a flat-type cathode ray tube having an improved panel, which enhances proof-explosion properties caused in the course of making a color cathode ray tube large-sized and inner and outer surfaces thereof flat-typed. The flat-type cathode ray tube according to the present invention comprises: a rectangular panel, which includes a flat outer surface, an inner surface having a predetermined curvature, and a skirt portion substantially perpendicularly extending from the inner and outer surfaces; and a funnel coupled to an actual edge of the skirt portion of the panel. In the flat-type cathode ray tube according to the present invention, when radiuses of curvature R of brands of a long edge, a short edge and an opposite angle where an outer surface of the panel comes in contact with the skirt portion are R1, R2 and R3, respectively, and radiuses of curvature r of brands of a long edge, a short edge, and an opposite angle where an end of effective surface of the panel comes in contact with the skirt portion at the inner surface of the panel are r1, r2, and r3, respectively, the following formula is satisfied: 1.3=R1/R3<2.0 and 1.3=R2/R3<2.0.

### BACKGROUND OF THE INVENTION

1. Field of the Invention

The present invention generally relates to a flat-type color cathode ray tube, and more particularly to a flat-type color cathode ray tube having an improved panel, which enhances proof-explosion properties caused in the course of making a color cathode ray tube large-sized and inner and outer surfaces thereof flat-typed, and improves quality of a screen as well.

2. Description of the Related Art

In general, a flat-type cathode ray tube comprises, as shown in FIG. 1, a panel 1 as a front glass coupled to a funnel 2 as a rear glass, a luminescence screen 4 for illuminating at an inner surface of the panel 1, an electron gun as an origin of an electronic beam 5 illuminating the luminescence screen 4, a shadow mask 3 for sorting out colors to illuminate a predetermined luminescence material, and a main frame 7 for supporting the shadow mask 3.

Furthermore, a spring 8, which couples the main frame 7 mounting the shadow mask 3 thereon to the panel, and an inner shield 9, protects the cathode ray tube from an external terrestrial magnetism during their operations and make the cathode ray tube being hermetically sealed, are fixed to the main frame 7 in a high vacuum state.

An operational principle of the color cathode ray tube of FIG. 1 will be described herein below. The electric beam 6 emitted from the electron gun housed in a neck portion of the funnel 2 strikes the luminescence screen 4 formed at the inner surface of the panel 1 due to an anode voltage an applied to the cathode ray tube. At this time, the electronic beam 6 is deflected vertically and horizontally by a deflection yoke 5 before reaching the luminescence screen, thereby composing a picture image.

A diode, tetrode or hexode magnet 10 adjusts the electric beams progressive track in order for the electronic beam 6 to accurately strike the predetermined luminescence material, thereby minimizing a rejection rate of color purity. Since the cathode ray tube is in the high vacuum state, it tends to be easily fire-cracked due to an external impact. Thus, the panel is designed to have a strength resistible against atmospheric pressure. Additionally, a safety band 14 is disposed on an outer surface of the skirt portion of the panel 1 to disperse a stress applied to the high vacuum cathode ray tube and assure impact resistance.

The conventional cathode ray tube is roughly comprised of the panel 1 and the funnel 2, and sealed by inserting the electron gun into the neck portion of the funnel 2 and making vacuous through an air exhausting process. When the bulb becomes vacuous in this way, the panel 1 and the funnel 2 suffer a drastic amount of tension and compressive force. Accordingly, an excessive tensile stress is present at a specific position of the screen of the panel 1.

Let us assume that brands R of a long side, a short side, and an diagonal are R1, R2, and R3, (here, the brand R represents the radius of curvature at a portion where a face and side surfaces of the panel come in contact with each other then to be curved in a shape of character L, while the radius of curvature at the inner surface of the panel is referred to as a brand r). In the conventional panel structure, the value of R1, R2 and R3 are designed to same or R1/R3 is designed to be less than 1.3, and the safety band is used to assure the impact resistance.

The panel 1 is currently been directed to being large-sized itself and being flatted at the inner and outer surfaces thereof. In particular, since both the inner and outer surfaces are flatted, the panel cannot help weakening in its proof-explosion characteristics.

Use of a hardened glass panel formed by enhancing glass strength only through a thermal treatment without altering its physical property is considered in order to obviate the deterioration in the explosion proof. However, the problem of the weakness of the proof-explosion properties in the conventional panel still remains after the application of the thermal-treated hardened glass.

FIG. 2 and FIG. 3 show a distribution of a vacuum stress before and after the air exhausting process and after the strengthening treatment. In the drawings, an excessive stress is found to be present at a specific region. If an impact is applied to the region where the vacuum stress is weakly distributed, a crack or a fire-crack would be easily led to, thereby threatening the safety.

Thus, the panel is needed to be thick in order to overcome the weakness of the proof-explosion properties caused by the conventional structure wherein vertical ends of the panel are weak against the stress. However, there is a tendency that the cathode ray tube deteriorates in brightness, one of the most important qualities thereof, as the panel is thicker in an aspect of the screen characteristic. Thus, to enhance the deteriorated brightness, width of the region coated with the luminescence material should be increased, and width of the band for sorting out colors of the luminescence material should be decreased. Still, this conventional structure has a limit in increasing the thickness of the panel, since thickening the panel is contrary to the requirement of raising the color purity.

### SUMMARY OF THE INVENTION

It is, therefore, an object of the present invention to provide a flat-type cathode ray tube having an proof-explosion properties against an external impact by enhancing a panel in consideration of brands R of a long side, a short side and an diagonal, where effective surfaces at inner and outer surfaces of the panel intersect a skirt portion of the panel.

To achieve the above object, there is provided a flat-type cathode ray tube comprising: a rectangular panel, which includes a flat outer surface, an inner surface having a predetermined curvature, and a skirt portion substantially perpendicularly extending from the inner and outer surfaces; and a funnel coupled to an actual edge of the skirt portion of the panel. When brands R of the long side, the short side and the diagonal where the outer surface of the panel comes in contact with the skirt portion are R1, R2 and R3, respectively, and brands r of the long side, the short side, and the diagonal where an end of the effective surface of the panel comes in contact with the skirt portion at the inner surface of the panel are r1, r2, and r3, respectively, the flat-type cathode ray tube according to the present invention satisfies requirements expressed in the following formula: 1.3=R1/R3<2.0 and 1.3=R2/R3<2.0.

The flat-type cathode ray tube according to the present invention also satisfies the following formula: r2/r3>2.

When a central axis in the horizontal direction and a central axis in the vertical direction of the effective surface of the panel are referred to as an X-axis and an Y-axis, a distance between the center of r1 and the Y-axis as an L1, a distance between the center of r2 and the X-axis as an L2 and a distance between the center of r3 and an intersection point of the X-axis and the Y-axis as an L3, it is preferable that the present invention satisfies the following formula: L2−L3×cosö>r2−r3.

The present invention also satisfies the following formula: r1/r3>1.5.

When a central axis in the horizontal direction and a central axis in the vertical direction of the effective surface of the panel are referred to as an X-axis and an Y-axis, a distance between the center of r1 and the Y-axis as an L1, a distance between the center of r2 and the X-axis as an L2 and a distance between the center of r3 and an intersection point of the X-axis and the Y-axis as an L3, it is preferable that the present invention satisfies the following formula: L1−L3×sinö>r1−r3.

It is also preferable that the present invention satisfies one or more among the following formulas: 1.65<R1/r1<1.75, 1.35<R2/r2<1.75 and 0.9<R3/r3<1.0.

### BRIEF DESCRIPTION OF THE DRAWINGS

The above and other objects, features and advantages of the present invention will become more apparent from the following detailed description when taken in conjunction with the accompanying drawings, in which:

FIG. 1 is a schematic sectional view showing a construction of a general color cathode ray tube;

FIG. 2 is a view showing a distribution of tensile stress after conducting an air exhausting process in the color cathode ray tube;

FIG. 3 is a view showing a distribution of tensile stress after conducting a strengthening treatment in the color cathode ray tube;

FIG. 4 is a view showing positions of brands R at an outer surface of a panel of the cathode ray tube;

FIG. 5 is a view showing positions of brands r at an inner surface of the panel of the cathode ray tube;

FIG. 6 is a detailed view showing a construction of inner and outer surfaces of a panel of a color cathode ray tube according to the present invention;

FIG. 7 is a view showing a construction of the panel of the color cathode ray tube according to the present invention;

FIG. 8 is a view showing a variation of tensile stress at a point A according to a value R1/R2 of the present invention;

FIG. 9 is a view showing a variation of tensile stress at a point B according to a value R2/R3 of the present invention;

FIG. 10 is a view showing a variation of stress at an end of an X-axis according to a value r2/r3 of the panel; and

FIG. 11 is a view showing a decrement of thickness of the panel according to a size of an opposite angle at an effective surface of the panel.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

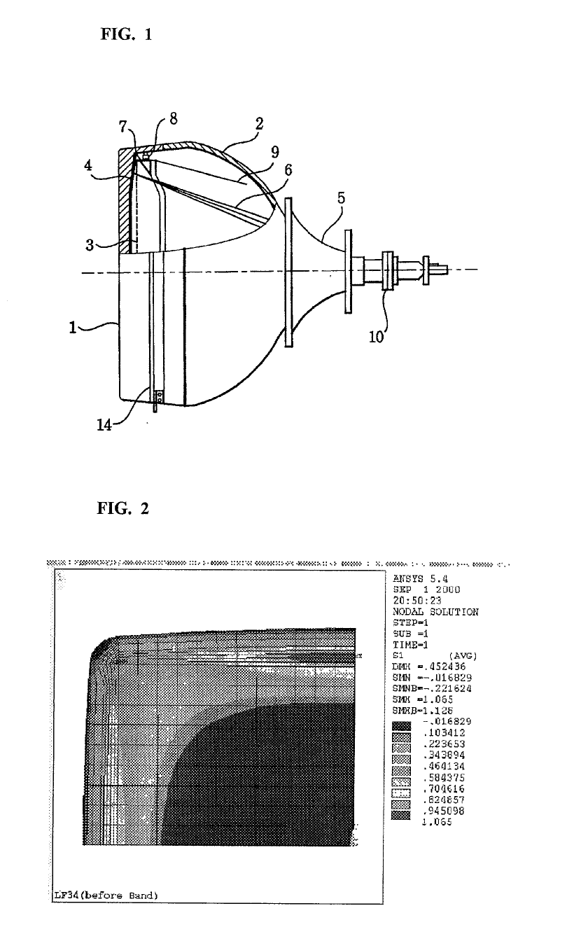

A color cathode ray tube generally comprises, as shown in FIG. 1, a panel 1 as a front glass and a funnel 2 as a rear glass being coupled to the panel 1, a luminescence screen 4 for illuminating at an inner surface of the panel, an electron gun as an origin of an electronic beam 6 illuminating the luminescence screen 4, a shadow mask for sorting out colors to illuminate a predetermined luminescence material, and a main frame 7 for supporting the shadow mask 3. The present invention relates to a panel structure, which is roughly divided into a face and side surfaces. The radius of curvature at a decreasing region where the face and side surfaces come in contact with each other is referred to as a brand R.

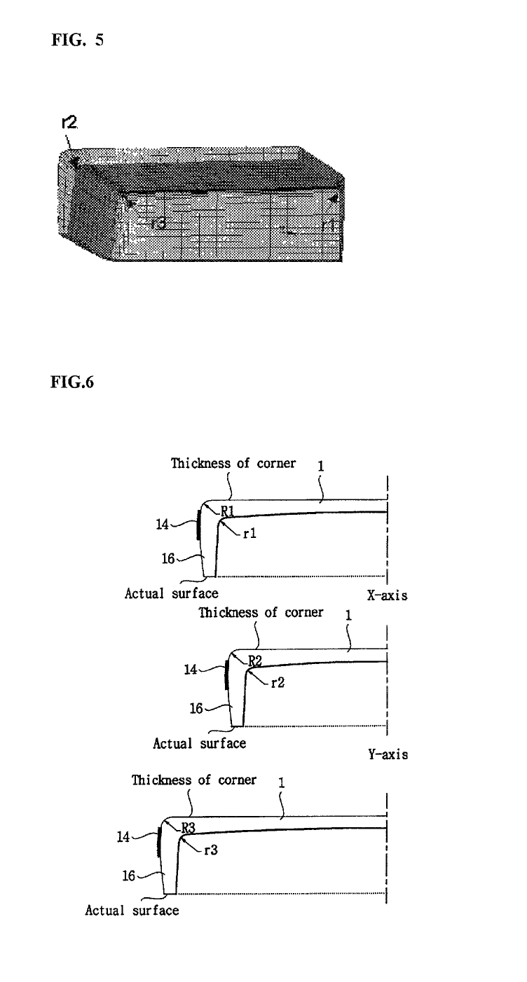

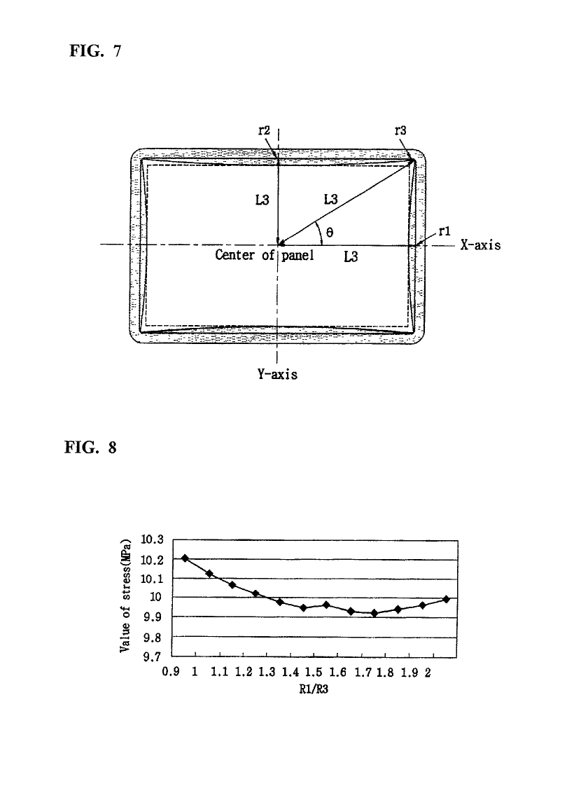

Referring to FIGS. 4, 5, 6, and 7, the brand R exists at both inner and outer surfaces. The radius of curvature at the inner surface is referred to as a brand r, whereas the radius of curvature at the outer surface is referred to as the brand R. The present invention is specifically related to the brand R at the outer surface and the brand r at the inner surface. When the brands R of a long side, a short side and an diagonal at the outer surface of the panel are R1, R2 and R3, respectively, while the brands r of a long side, a short side and an diagonal at the inner surface of the panel are r1, r2 and r3, respectively, the brand R at the outer surface satisfies the following formula: 1.3=R1/R3<2.0 and 1.3=R2/R3<2.0. Relations between the brand R and the brand r satisfy the following formula: 1.65<R1/r1<1.75, 1.35<R2/r2<1.75, and 0.9<R3/r3<1.0.

In addition, the brand r at the inner surface satisfies the following formula: r2/r3>2, and r1/r3>1.5. Furthermore, when a central axis in the horizontal direction and a central axis in the vertical direction of the effective surface of the panel are referred to as an X-axis and an Y-axis, a distance between the center of r1 and the Y-axis as an L1, a distance between the center of r2 and the X-axis as an L2 and a distance between the center of r3 and an intersection point of the X-axis and the Y-axis as an L3, it is preferable that relations of the brands R and r satisfy the following formula: L2−L3×cosö>r2−r3 and L1−L3×sinö>r1−r3.

Explanation with respect to an operation of the present invention will be made herein below.

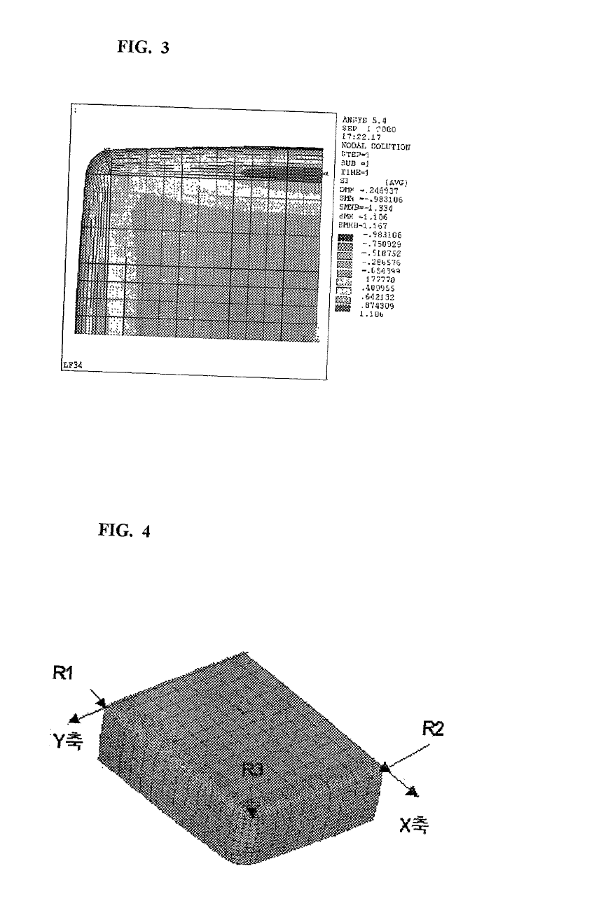

The cathode ray tube of the present invention is roughly comprised of the panel and the funnel, and sealed by inserting the electron gun at a neck portion of the funnel and making vacuous through an air exhausting process. When the bulb becomes vacuous in this way, the panel and the funnel suffer a huge amount of tension and compressive force. As shown in FIG. 3, an excessive tensile stress is accordingly present at ends of the X-axis and the Y-axis of the screen of the panel. If an external impact is applied to the region showing the excessive tensile stress, a crack or a fire-crack is possibly led to, thereby threatening the safety.

The panel of the present invention satisfies requirements of the formula: 1.3=R1/R3<2.0 and 1.3=R2/R3<2.0. That is, since the values of R2 and R1 are relatively greater than the value of R3, respectively, the radius of curvature is getting smaller as it goes from the R2 toward the R3. The panel constructed as above is capable of reducing a residual stress at the ends of the X-axis and the Y-axis of the screen which are weak against the stress, and rapidly transmitting an impact applied thereto toward a diagonal corner side to prevent the crack or the fire-crack from being occurred since the brand R is greater even in case of the impact application.

The brand R at the outer surface is preferably greater than the brand r at the inner surface to stabilize the panel. Nevertheless, if the brand R is excessively greater than the brand r, the stress is concentrated again on the brand r at the inner surface of the panel. Therefore, it is more desirable that the relations of the brands R and r satisfy the following formula: 1.65<R1/r1<1.75, 1.65<R1/r1<1.75, and 0.9<R3/r3<1.0.

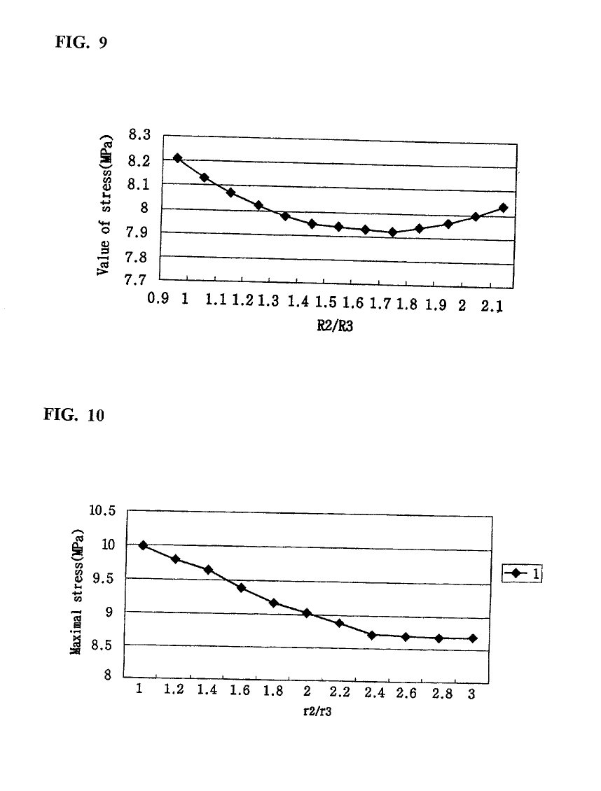

FIG. 8 and FIG. 9 are views showing a variation of tensile stress at a point A according to the value of R1/R3 of the present invention and a variation of tensile stress at a point B according to the value of R2/R3 of the present invention, respectively. Referring to the drawings, a sufficiently lower vacuum stress is found to be distributed under the condition expressed by the formula: 1.3=R1/R3<2.0 and 1.3=R2/R3<2.0.

In the conventional panel, the brand r at the inner surface is designed in a range of 1<r2/r3<e. Such a structure is ineffective in reducing the stress imparted at the ends of the X-axis and the Y-axis of the screen. Therefore, the present invention provides the panel satisfying requirements of the following formula: r2/r3>2 and r1/r3>1.5. If the panel satisfies the following formula: L2−L3×cosö>r2−r3 and L1−L3×sinö>r1−r3, a line, which connects the brand r representing the short side to the brand r representing the diagonal at the inner surface of the panel, gets to have an inverse curvature when being seen from the center of the panel, thereby achieving a fast transmission of any external impact applied thereto toward the diagonal corner side.

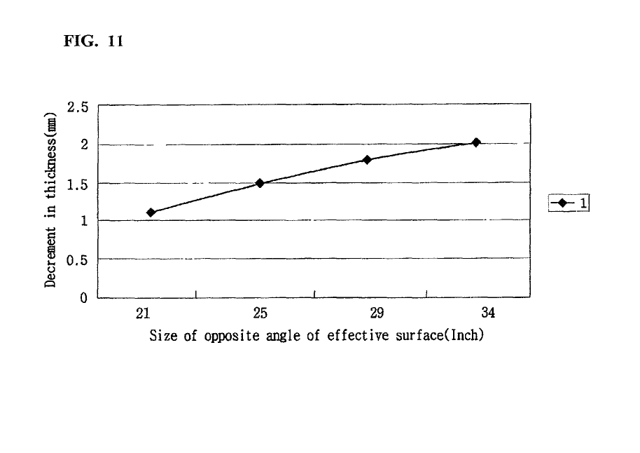

FIG. 10 is a view showing a variation of stress at the end of the X-axis according to the value r2/r3 of the panel. Referring to the drawing, the stress is found to be decreased under the condition expressed as the following formula: r2/r3>2. The stress decreasing effect is also obtained under the condition of r1/r3>1.5 in accordance with the present invention, in contrary to the conventional panel.

The present invention has another advantage of improving the quality of the screen since thinner panel is manufactured by virtue of the effective decrease in the stress. Once the center of the panel becomes thinner, the brightness, one the most important qualities of the color cathode ray tube, can be improved, and the width of the region coated with the luminescence material can be reduced as well as the width of the band for sorting out colors R, G, and B of the luminescence material can be increased. Subsequently, the increase in the width of the band for sorting out the colors R, G, and B of the luminescence material enhances redundancy in the color purity, achieving improvements in the quality of the screen.

FIG. 11 is a view showing a decrement of thickness of the panel according to a size of the opposite angle at the effective surface of the panel. Referring to the drawing, the thickness of the panel is found to be decreased at the center thereof.

As stated above, the present invention has the proof-explosion properties sufficiently resistible against the external impact by strengthening the panel in consideration of the brands R of the long side, the short side and the diagonal, where the effective surfaces at the inner and outer surfaces of the panel come in contact with the skirt portion.

Hence, the present invention has still another advantage of improving the proof-explosion properties by effectively decreasing the stress excessively imparted at the ends of the long axis and the short axis after conducting the air exhausting process in the cathode ray tube of the flatted inner and outer surfaces, and improving the quality of the screen as well by increasing the color purity redundancy.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A flat-type cathode ray tube comprising:
a rectangular panel including a flat outer surface, an inner surface having a predetermined curvature, and a skirt portion substantially perpendicularly extending from the inner and outer surfaces; and
a funnel coupled to an actual edge of the skirt portion of the panel,
wherein when radiuses of curvature R of brands of a long side, a short side and an diagonal where an outer surface of the panel comes in contact with the skirt portion are R1, R2 and R3, respectively, and radiuses of curvature r of brands of a long side, a short side, and an diagonal where an end of an effective surface of the panel comes in contact with the skirt portion at the inner surface of the panel are r1, r2, and r3, respectively, the following formula is satisfied: 1.3=R1/R3<2.0 and 1.3=R2/R3<2.0.

2. The flat-type cathode ray tube of claim 1, wherein the following formula is satisfied: 1.65<R1/r1<1.75.

3. The flat-type cathode ray tube of claim 1, wherein the following formula is satisfied: 1.35<R2/r2<1.75.

4. The flat-type cathode ray tube of claim 1, wherein the following formula is satisfied: 0.9<R3/r3<1.0.

5. A flat-type cathode ray tube comprising:
a rectangular panel including a flat outer surface, an inner surface having a predetermined curvature, and a skirt portion substantially perpendicularly extending from the inner and outer surfaces; and
a funnel coupled to an actual edge of the skirt portion of the panel,
wherein when radiuses of curvature r of brands of a long side, a short side and an diagonal, where an end of an effective surface of the panel comes in contact with the skirt portion at the inner surface of the panel, are r1, r2 and r3, respectively, the following formula is satisfied: r2/r3>2.

6. The flat-type cathode ray tube of claim 5, wherein when a central axis in the horizontal direction and a central axis in the vertical direction of the effective surface of the panel are referred to as an X-axis and an Y-axis, a distance between the center of r1 and the Y-axis as an L1, a distance between the center of r2 and the X-axis as an L2 and a distance between the center of r3 and an intersection point of the X-axis and the Y-axis as an L3, the following formula is satisfied: L2−L3×cosö>r2−r3.

7. A flat-type cathode ray tube comprising:
a rectangular panel including a flat outer surface, an inner surface having a predetermined curvature, and a skirt portion substantially perpendicularly extending from the inner and outer surfaces; and
a funnel coupled to an actual edge of the skirt portion of the panel,
wherein when radiuses of curvature r of brands of a long side, a short side and an diagonal, where an end of an effective surface of the panel comes in contact with the skirt portion at the inner surface of the panel, are r1, r2 and r3, respectively, the following formula is satisfied: r1/r3>1.5.

8. The flat-type cathode ray tube of claim 7, wherein when a central axis in the horizontal direction and a central axis in the vertical direction of the effective surface of the panel are referred to as an X-axis and an Y-axis, a distance between the center of r1 and the Y-axis as an L1, a distance between the center of r2 and the X-axis as an L2 and a distance between the center of r3 and an intersection point of the X-axis and the Y-axis as an L3, the following formula is satisfied: L1−L3×sinö>r1−r3.
